(19) United States
(12) Patent Application Publication
(10) Pub. No.: US 2005/0257193 A1
(43) Pub. Date: Nov. 17, 2005

(54) Method and system for visual data mapping and code generation to support data integration

(76) Inventors: Alexander Falk, Marblehead, MA (US); Vladislav Gavrielov, Wien (AT)

Correspondence Address: LAW OFFICE OF DAVID H JUDSON, 15950 DALLAS PARKWAY, SUITE 225, DALLAS, TX, 75248, US

(21) Appl. No.: 10/844,985

(22) Filed: May 13, 2004

(51) Int. Cl. G06F 9/44

(52) U.S. Cl. 717/109

(57) ABSTRACT

A data integration method and system that enables data architects and others to simply load structured data objects (e.g., XML schemas, database tables, EDI documents or other structured data objects) and to visually draw mappings between and among elements in the data objects. From there, the tool auto-generates software program code required, for example, to programmatically marshal data from a source data object to a target data object.

This application includes subject matter that is protected by copyright. All rights are reserved.

### BACKGROUND OF THE INVENTION

1. Technical Field

The present invention relates generally to data integration and, in particular, to techniques for visually developing data transformations and generating mapping code to implement such transformations in a programmatic manner.

2. Description of the Related Art

Organizations today are realizing substantial business efficiencies in the development of data intense, connected, software applications that provide seamless access to database systems within large corporations, as well as externally linking business partners and customers alike. Such distributed and integrated data systems are a necessary requirement for realizing and benefiting from automated business processes, yet this goal has proven to be elusive in real world deployments for a number of reasons including the myriad of different database systems and programming languages involved in integrating today's enterprise back-end systems.

Extensible Markup Language (XML) technologies are ideally suited to solve advanced data integration challenges, because they are both platform and programming language neutral, inherently transformable, easily stored and searched, and already in a format that is easily transmittable to remote processes via XML-based Web services technologies. XML is a subset of SGML (the Structured Generalized Markup Language) that has been defined by the World Wide Web Consortium (W3C) and has a goal to enable generic SGML to be served, received and processed on the Web. XML is a clearly defined way to structure, describe, and interchange data. XML technologies offer the most flexible framework for solving advanced data integration applications. They do not, however, encompass the entire solution, in that a particular solution must still be implemented. Thus, XML technologies are not a standalone replacement technology, but rather a complementary enabling technology, which when bound to a particular programming language and database provide an elegant solution to a different problem.

The vast majority of enterprise data today is stored in relational databases, owing to the efficiency, simplicity, and cost effectiveness of the relational database model. Relational databases are likely to remain the dominant storage mechanism for enterprise data in the foreseeable future. Despite countless strengths of the relational database model, there are several shortcomings which make relational database systems inherently difficult to integrate in large scale enterprise applications. Although relational databases have many similarities, there are enough differences between major commercial implementations to make it difficult to work with different databases together, including differences in data types, varying levels of conformance to the SQL standard, proprietary extensions to SQL, and different internal scripting languages and data access protocols. Relational databases were initially developed over 30 years ago in an era which pre-dates the widespread adoption of modern object oriented programming languages that are widely in use today. It has therefore, never been easy to map between tables and objects, which is a frequently encountered task in any data integration project. Moreover, programmatic access of relational databases is done via proprietary binary data access protocols such as JDBC, ADO, ODBC, and the like. Although these techniques are highly efficient and drivers exist for most database servers, they are not open enough to provide the transparency that is sometimes needed for the most advanced data integration projects.

The following provides additional background concerning the state of the art. XML Schema, an XML-based meta-language for describing XML data constructs, is ideally suited for data integration for a variety of reasons including: support for a built-in data type library which resembles SQL data types, as well as support for several key object-oriented data modeling characteristics, including encapsulation, data type derivation, polymorphism, and namespaces. XML Schema therefore provides both a simplified means for mapping between database tables and software objects to enable programmatic manipulation of the data from within any data integration application, while simultaneously works as an adaptor to overcome any differences in various relational database implementations as discussed in the previous section.

Data encoded in an XML format can be transformed into that of any other XML data format using the extensible Stylesheet Language (XSL), a related XML technology. For example, a purchase order expressed in one XML format could be made to conform to the data model of a supplier's or customer data model through the application of an XSLT stylesheet. In a similar manner, XSL can be used to publish XML data into various, widely used output formats, such as HTML, WML, PDF, PostScript, plain text, and the like.

Enterprise data integration applications vary in scope and functionality, but in general terms have several commonalities. The most typical scenario is a business to business transaction or supply chain automation application which electronically links two or more companies, typically with different data models and back end systems. An illustrative example is a factory that desires to automate the purchasing of spare parts from a vendor using XML technologies, assuming that application connectivity details have been worked out. First, the factory's data integration architect must design an XML data model for a purchase order using XML schema, and develop the program code required to extract data from various internal database tables. The data is then constructed into an in-memory representation of a valid XML instance corresponding to the data model expressed in the XML Schema, using various XML processing Application Program Interfaces (API's). Once the purchase order is in an XML format (either in-memory or as a file) the data must be transformed into a format that will be recognized by the vendor's systems, and this involves transforming the data from one XML format to another, through the use of XSLT or program code.

Currently available products and solutions do not adequately address the needs in the art. Until the inefficiencies of the prior art are addressed, data integration projects will continue to rate among the most tedious developer tasks due to the volume of lines of infrastructure code required to load, persist, validate, and perform other routine operations on data within the software application.

The present invention addresses these and other problems associated with the prior art.

### BRIEF SUMMARY OF THE INVENTION

It is a principal object of the invention to provide a visual mapping and code generation tool for advanced data integration projects.

It is another more specific object of the present invention to provide a data integration tool that allows a developer to visually design structured data source-to-structured data target mappings (e.g., database-to-XML, XML-to-XML, or the like) and then automatically generates software code that programmatically implements such data mappings in a run-time environment.

A still more specific object of the invention is to provide a data integration system that enables data architects and others to simply load structured data objects (e.g., XML schemas, database tables, EDI documents or other structured data objects) and to visually draw mappings between and among elements in the data objects. From there, the tool auto-generates the software program code required, for example, to programmatically marshal data from a source data object to a target data object.

Another more specific object of the invention is to provide an XML/database/EDI visual mapping tool that automatically generates custom mapping code in multiple output languages including, e.g., XSLT, Java, C++, and C#. The tool includes a flexible visual design environment that enables mapping of any combination of XML, database and EDI (Electronic Data Interchange) data into, for example, XML and/or a database. Thus, the system allows the user the ability to mix multiple sources and multiple targets to map any combination of different data sources in a mixed environment. Preferably, all transformations are then available from one workspace, and a rich, extensible function library provides support for any kind of data manipulation. The function library, for example, may include prior designs that have been saved for reuse.

In an illustrative embodiment, a data integration method is operative in a data processing system having a windows-based graphical user interface (GUI). The method begins by displaying “n” structured data objects, wherein any given structured data object is positionable in any juxtaposition with respect to any other given structured data object. A designer then visually defines one or more mappings from a first structured data object to a second structured data object. In response, given program code is then automatically generated. The given program code enables programmatic data transformation from the first structured data object to the second structured data object in a given application execution environment. A preview of the programmatic data transformation may be selectively displayed to the designer during this design process. Preferably, the preview is generated using an interpreter engine, which shows an output without compiling the actual program code.

The first structured data object preferably is selected from a set of structured data objects that include, for example: an XML document, a relational database, an electronic data interchange (EDI) document, or combinations thereof. The second structured data object preferably is selected from a set of data objects that may include similar structured object types. The integration is not limited to just a single source data object and a single target data object. Using the visual design environment, the present invention facilitates XML-to-XML data integration, database-to-XML integration, database-to-database integration, XML and relational database-to-XML data integration, EDI and relational database-to-XML data integration, and other variants. Moreover, according to an embodiment of the invention, the given program code that is automatically generated may be in at least one of the following languages: Java, C++, C#, XSLT or others. Further, a given structured data object may also be saved and then retrieved and re-used in a subsequent data integration design project.

A given structured data object preferably is a display object that includes a structured content model representation, a first set of one or more sockets representing one or more inputs to the structured content model representation, and a second set of one or more sockets representing one or more outputs from the structured content model representation. The sockets facilitate creation of a given visual mapping when the data object is displayed in juxtaposition with one or more other data objects.

According to another feature of the present invention, one or more visual mappings from the first structured data object to the second structured data object may include a mapping from the first structured data object to the second structured data object through a given data processing element. The given data processing element generates a data processing function selected from a set of functions that include: a logical comparison, a mathematical computation, a string operation, a value checking operation, or a data modifier operation. In this embodiment, a data integration method begins by displaying at least the first second structured data objects, together with a given data processing element. The developer then visually defines at least one mapping from the first structured data object to the second structured data object through the given processing element. The given program code is then generated. Using this visually design technique, the present invention supports multi-stage data processing logic to enable the developer to pass the output of one function into the input of another function, chaining them together as required, before completing the data transformation. Preferably, the data processing functions are extensible so that user-defined functions are supported.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a data processing system that includes the visual design environment of the present invention;

FIG. 2 illustrates representative data mappings that may be created using the data integration tool of the present invention;

FIG. 3 illustrates a representative format of a structured display object for use within the visual design environment of the present invention;

FIG. 4 illustrates a representative visual design environment (VDE) display for use in creating data mappings according to the present invention;

FIG. 5A-5C illustrates how an end user may create a database-to-XML mapping using the VDE of FIG. 4 according to an embodiment of the present invention;

FIG. 6 illustrates a relational database that is imported into the visual design environment as a result of the selection process shown in FIG. 5A-5C;

FIG. 7 illustrates the database-to-XML mapping that visually develops as the user draws connector lines between data elements;

FIG. 8 illustrates a mapping wherein a data processing function is used to manipulate data between a first structured data object and a second structured data object;

FIG. 9 illustrates some of the available functions from the data processing function library according to an embodiment of the invention;

FIG. 10 illustrates a complex example wherein a first structured data object includes an XML schema and a relational database, and the second structured data object includes an XML Schema, and where several data processing functions have been used to implement the data transformation;

FIG. 11A-11C illustrates a user developing an XML-to-XML mapping according to the present invention;

FIG. 12 illustrates an XSLT stylesheet code that is generated in a representative embodiment;

FIG. 13A illustrates a preview of the results of the data transformation using the XSLT stylesheet code shown in FIG. 12;

FIG. 13B illustrates a representative output preview that displays the SQL commands that would be executed against a database as a result of a given mapping;

FIG. 14 illustrates a user developing a database-to-database mapping according to the present invention;

FIG. 15 illustrates a representative Database Table Actions dialog box from which a user may select database table actions to control how data is written to the database;

FIG. 16 illustrates an overview window graphic that may be displayed in the visual display environment to facilitate the design process; and

FIG. 17 illustrates a menu by which a user can match child elements in a given mapping.

### DETAILED DESCRIPTION OF AN EMBODIMENT

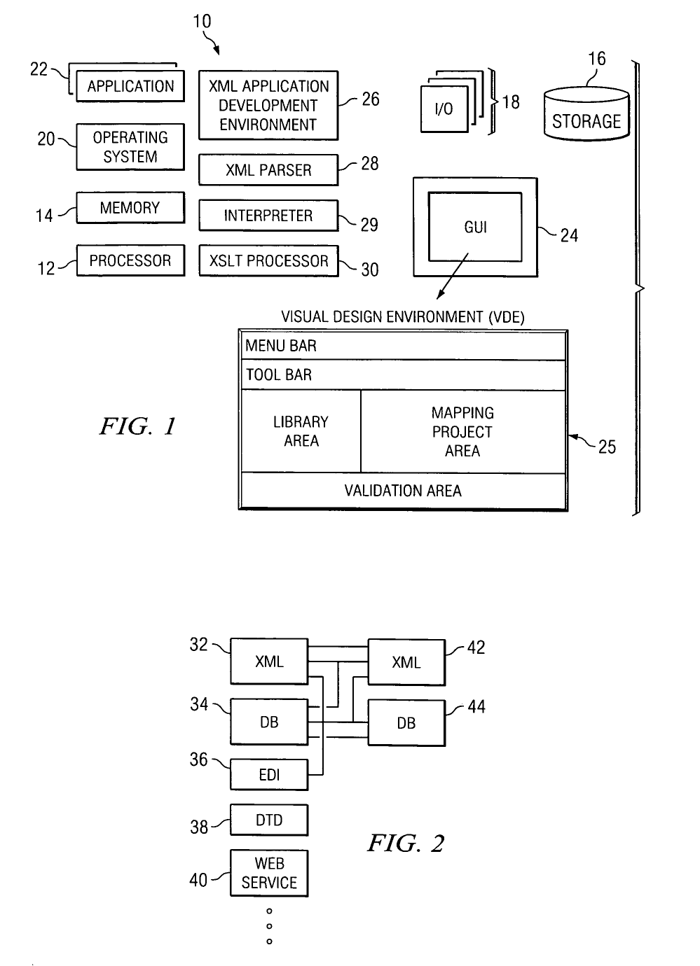

The present invention is implemented in a data processing system such as shown in FIG. 1. Typically, a data processing system 10 is a computer having one or more processors 12, suitable memory 14 and storage devices 16, input/output devices 18, an operating system 20, and one or more applications 22. One input device is a display 24 that supports a window-based graphical user interface (GUI). The data processing system includes suitable hardware and software components (not shown) to facilitate connectivity of the machine to the public Internet, a private intranet or other computer network. In a representative embodiment, the data processing system 10 is a Pentium-based computer executing a suitable operating system such as Windows 98, NT, W2K, or XP. Of course, other processor and operating system platforms may also be used. Preferably, the data processing system also includes an XML application development environment 26. A representative XML application development environment is xmlspy from Altova, GmbH. An XML development environment such as Altova xmlspy facilitates the design, editing and debugging of enterprise-class applications involving XML, XML Schema, XSL/XSLT, SOAP, WSDL, and Web services technologies. The XML development environment typically includes or has associated therewith ancillary technology components such as: an XML parser 28, an interpreter engine 29, and a given XSLT processor 30. These components may be provided as native applications within the XML development environment or as downloadable components.

According to the present invention, the XML development environment includes given software code (a set of instructions) for use in displaying an integrated visual design environment (VDE) 25 in which data mappings are created. The visual design environment may be an adjunct to the data processing system GUI, or native to the GUI. Representative data mappings are illustrated in FIG. 2. As seen in this example, a set of structured data objects include a first structured data object such as an XML document 32, a relational database 34, an EDI source 36, a Document Type Definition (DTD) 38, a Web service 40, or combinations thereof. A second structured data object, such as XML document 42, relational database 44, or the like, is being generated from the first structured data object. Thus, in an illustrative example, the first structured data object is XML document 32 and the second structured data object is XML document 42, created by an XML-to-XML mapping. In another example, the first structured data object is XML document 32 together with data from the relational database 34, and the second structured data object is XML document 42, created by an XML and database-to-XML mapping. Still another example would be a first structured data object that comprises XML document 32, relational database 34 and EDI source 36, with the second structured data object being XML document 42 or database 44. In that example, the EDI values would extracted from the database with the XML document being used to define a configuration, with the result being written to the target XML schema or database schema. Another example would be to have relational database 34 as the first structured data object and relational database 44 being the second structured data object. These examples are merely illustrative, as any particular combination of objects may be used.

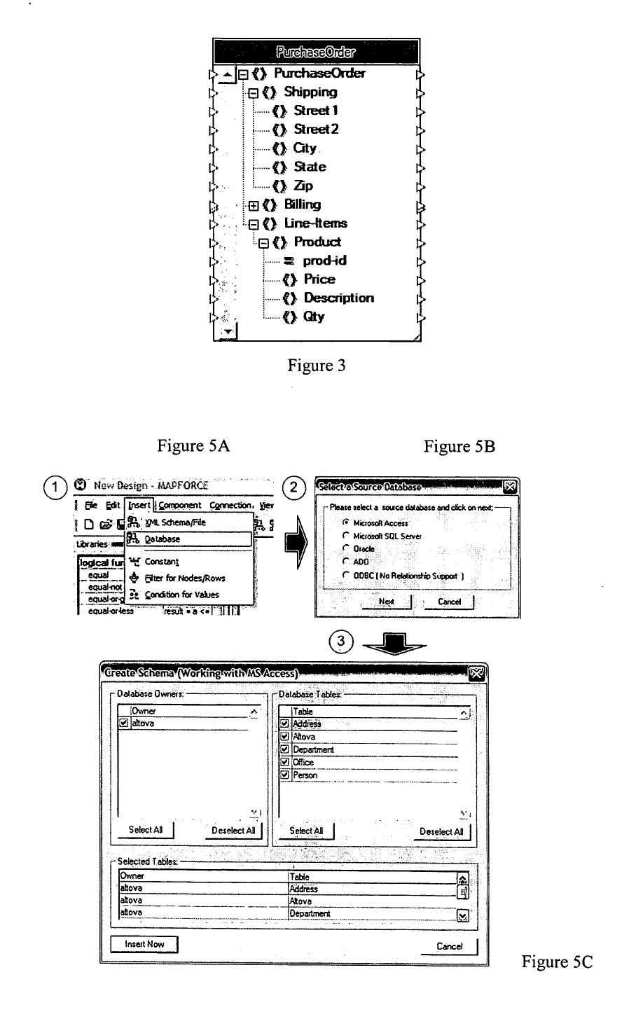

Moreover, a given data integration design that is created within the visual design environment is not limited to just a single source and target object. Rather, there may be two or more (or, in general, a plurality) of structured data objects that can be displayed and connected together in any useful or desirable manner. Two or more structured data objects may be cascaded in a pipeline (i.e. a given sequence), may be connected in parallel, or may be connected in any other convenient manner. To this end, each display object preferably has the structure illustrated in FIG. 3. As seen in this drawing, a given display object 46 includes a given structured content model representation 48 that depends on the object itself, a first set of one or more sockets 50a-n representing one or more inputs to the structured content model representation, and a second set of one or more sockets 52a-n representing one or more outputs from the structured content model representation. A given socket is a connection point (and may be illustrated as a triangle or other figure) that may function as an input or an output. Connections between sockets typically are made by having the end user perform a drop-and-drag operation. For example, a user clicks an icon at a socket and performs a drag operation, which creates a mapping connector on the display. This line can then be “dropped” on another icon (i.e. another socket) somewhere else on the display to create a connector or connector line between the two sockets. Preferably, a link icon appears next to the text cursor when the drop action is allowed. Typically, an input icon has only one connector, although an output connector can have several connectors, each to a different input icon. As can be seen, the sockets facilitate creation of a given visual mapping when the data object is displayed in juxtaposition with one or more other data objects. In particular, because a given display object has selective inputs and outputs (as represented by the sockets), the object can be used at any position within the transformation that is being developed. This provides significant flexibility over prior art approaches that only enable certain types of data sources to take on predefined (and, as a result, limited) roles.

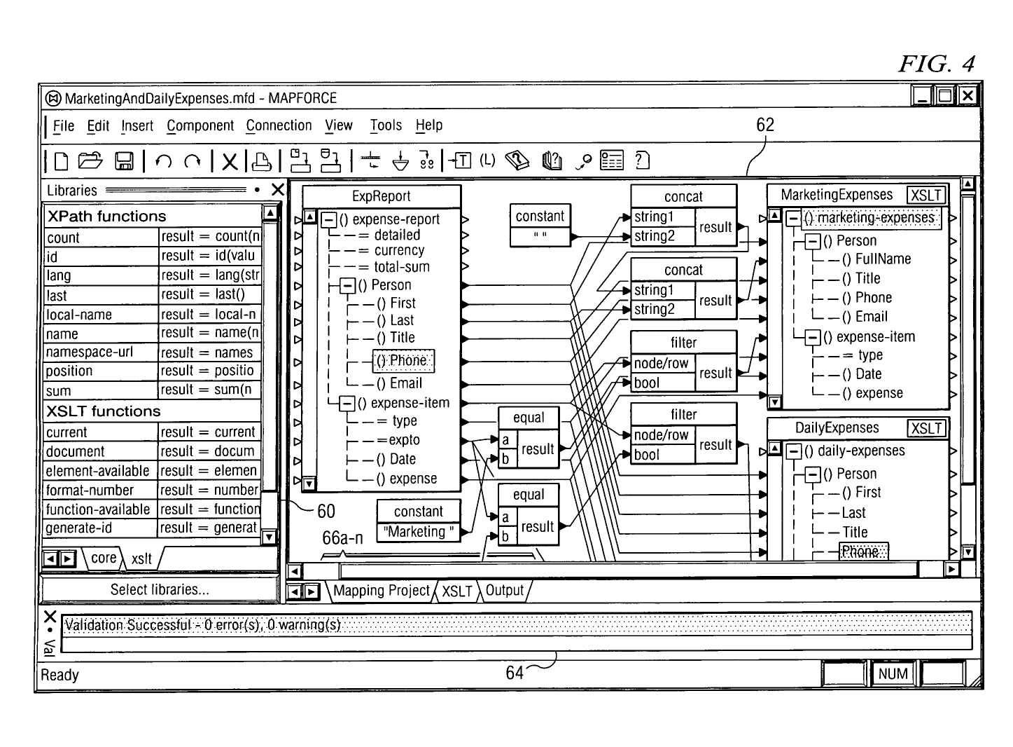

As seen in FIG. 4, the visual display environment (VDE) 25 preferably includes several viewing areas: a library pane 60, a mapping project area 62, and a validation pane 64. The actual mapping process typically occurs by manipulating on-screen graphical elements as will be described. The library pane 60 preferably displays currently available libraries, e.g., as a hierarchical tree, as well as individual library functions of each library; preferably, the individual library functions are displayed underneath their respective parent element so that they can be collapsed or expanded as needed. Functions can be directly dragged into the mapping project area 62. In addition, a Select Libraries button allows the user to import external libraries into the library tree display. The mapping project area 62 displays the graphical elements used to create the mapping (i.e., transformation) between the first and second structured data object schemas. Preferably, this is accomplished by having the end user draw “connectors” that serve to connect input and output icons of each schema item. A connector is a line that typically joins two icons, and it represents a mapping between the two sets of data the icons represent. Schema items can be either elements or attributes. Each one of a set of tabs 66a-n enables the user to select a “preview” of the transformation. Thus, for example, selection of XSLT tab displays an XSLT preview of the transformation. As illustrated in FIG. 1, preferably the tool includes an interpreter engine 29 that is used to generate a respective Java, C++ or C# preview of the output code without compilation. Typically, there will be a different interpreter engine for each language. An output tab 68 displays a preview of the transformed XML instance document, containing the mapped data, in a text view display. The validation pane 64 displays any validation warnings or error messages that might occur during the mapping process.

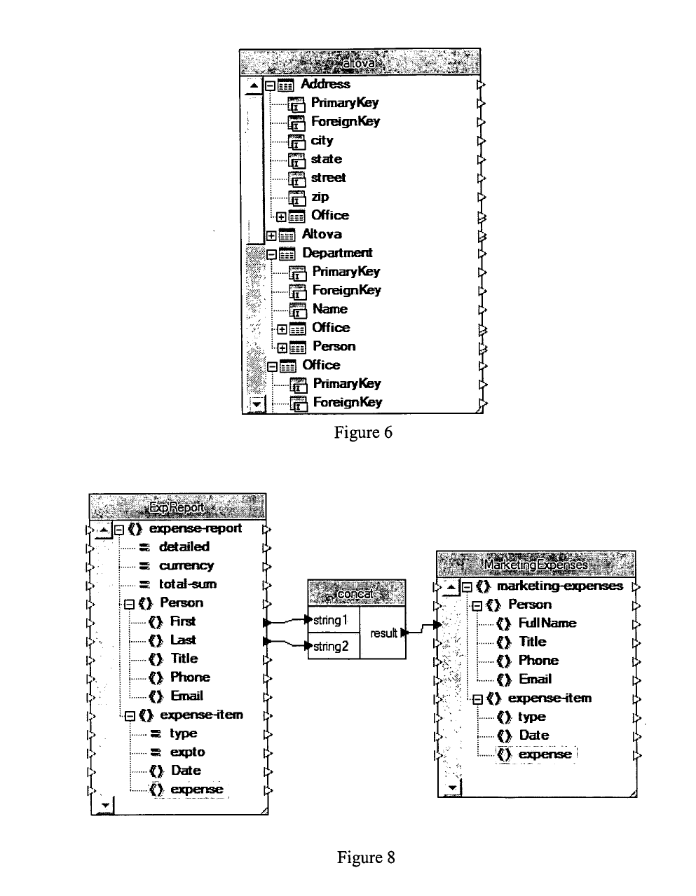

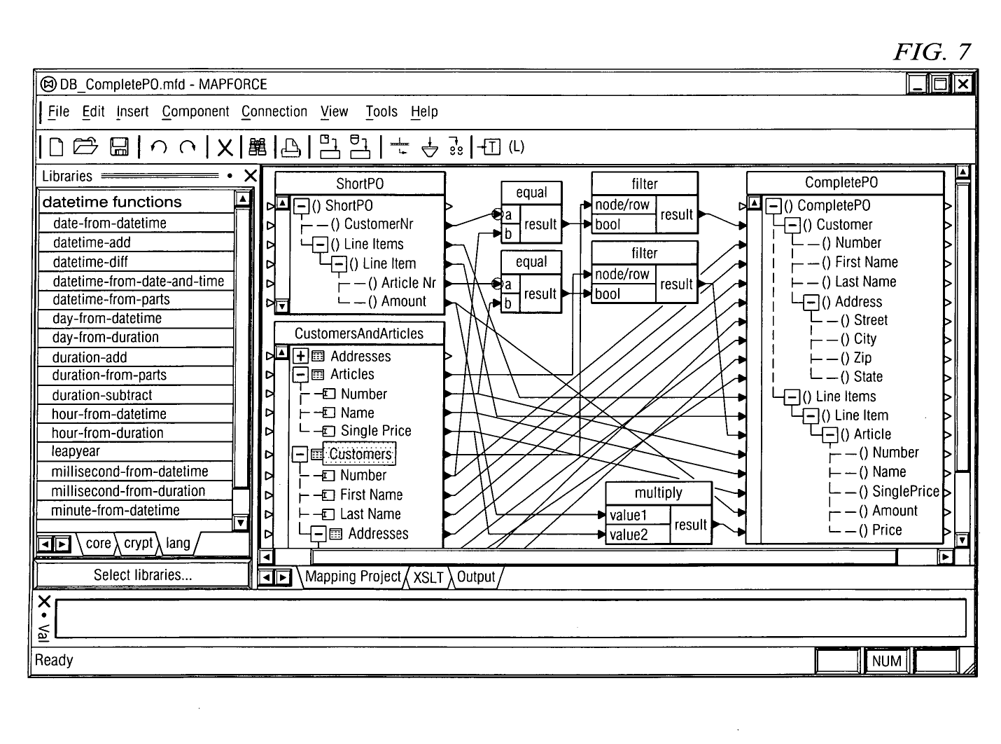

FIG. 5A-5C illustrates how the VDE can be used to create a database-to-XML mapping according to the present invention. The user begins by selecting Database from the Insert tab on the menu shown in FIG. 5A. Next, the user chooses (from the “Select A Source Database” menu) one of the supported relational databases, which in this illustrated example include the following: Microsoft Access, Microsoft SQL Server, Oracle (via OCI), MySQL, Sybase, IBM DB2, or any database that supports either Active Data Objects (ADO) or Open Database Connectivity (ODBC) drivers. This is illustrated in FIG. 5B. Of course, the above list is merely representative. The user the selects (from the “Create Schema” display menu, FIG. 5C) the tables he or she wishes to insert, and clicks the “Insert Now” button. The imported database model is represented visually in the tool as shown in FIG. 6. Then, the user loads into the tool one or more XML content models, e.g., models expressed in XML Schema, and visually develops the mappings from the database model to the XML model(s), e.g., by drawing connector lines between data elements. This process has been described generally above. FIG. 7 is an illustrative database-to-XML mapping.

Typically, most practical database mappings will not be just a one-to-one mapping of a database to an XML representation with the same database structure. Real-world data mappings often involve the use of data processing functions to manipulate data between the database and the target XML Schema mapping, or they require searching a database for a particular value. According to the present invention, one or more data processing elements are available for use in providing a data manipulation to a data element before completing the mapping. FIG. 8 illustrates this technique. In this example, the source XML schema (Expense Report) has a Person data element that has separate child elements for First (first name) and Last (last name), wherein the target XML schema (Marketing Expenses) only has a single data element: FullName, for both first and last name. Using the present invention, a mapping is defined that uses a “concat” (concatenation) data processing function, which takes the data contained in two separate elements and concatenates them into a single data element, which then fits in the target XML schema.

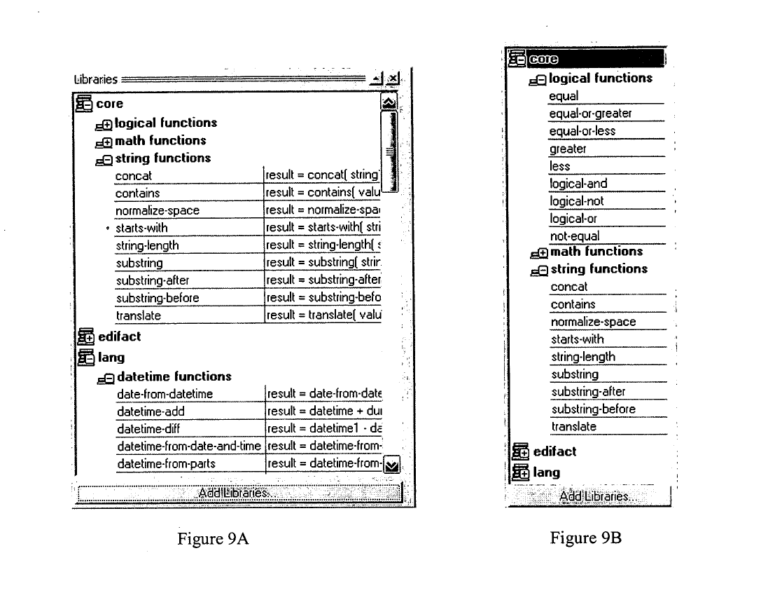

In an illustrative embodiment, the library pane includes a function library for building data processing functions, to perform any computational operation on data to make it adhere to the content model of the target structured data object. FIG. 9A illustrates some of the available functions from the library, which include logical operators, mathematical functions, common string operations, date/time functions, and others. As described above, preferably the currently available libraries are displayed as a hierarchical tree, with the individual library functions displayed underneath their respective parent element so they can collapsed or expanded. This is illustrated in FIG. 9B. To use a data processing function, the user simply drags and drops the function from the function library into the main design area and then connects the desired elements from the first structured data object into the inputs of the data processing function, and connects the output of the data processing function to the second structured data object.

A data processing function may be a previously generated design that has been saved into the library. Thus, for example, the data processing function may be an operation that encapsulates one or more visual mappings between a first structured data object and a second structured data object, where that composite “design” has been saved as a re-useable library object. A given “design” can then be re-used by the developer or others as needed. This provides enhanced flexibility of the visual design system and reduces expense.

In like manner, a given structured data object can be saved and re-used on an as-needed basis. One of ordinary skill in the art also will appreciate that the present invention enables the developer to generate new program code versions in a simple and expedient manner, e.g., by simply modifying the visual mappings between a given first structured data object and a second structured data object that is being generated from the first structured data object.

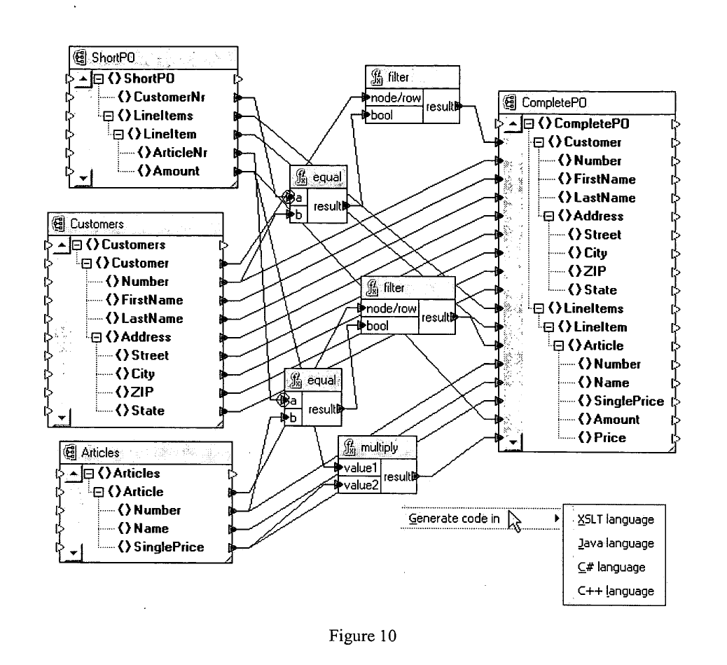

FIG. 10 illustrates a complex example wherein a first structured data object includes the “CustomersAndArticles” database and the “ShortPO” XML Schema and the second structured data object includes the “CompletePO” XML Schema. In this example a number of different data processing functions have been utilized. Of course, this example is merely illustrative of the general visual design technique.

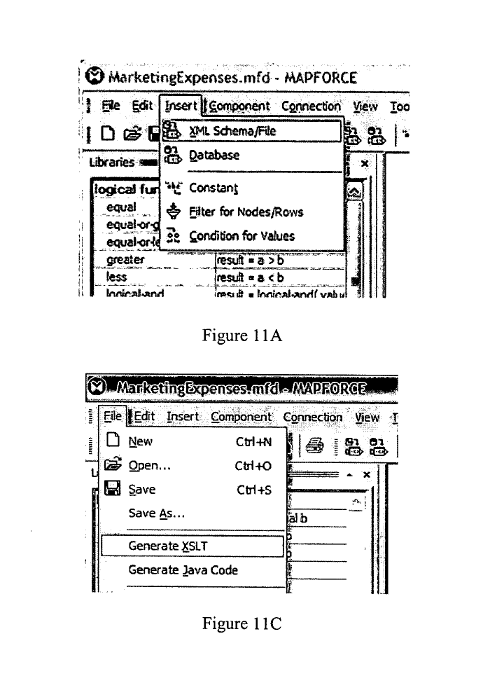

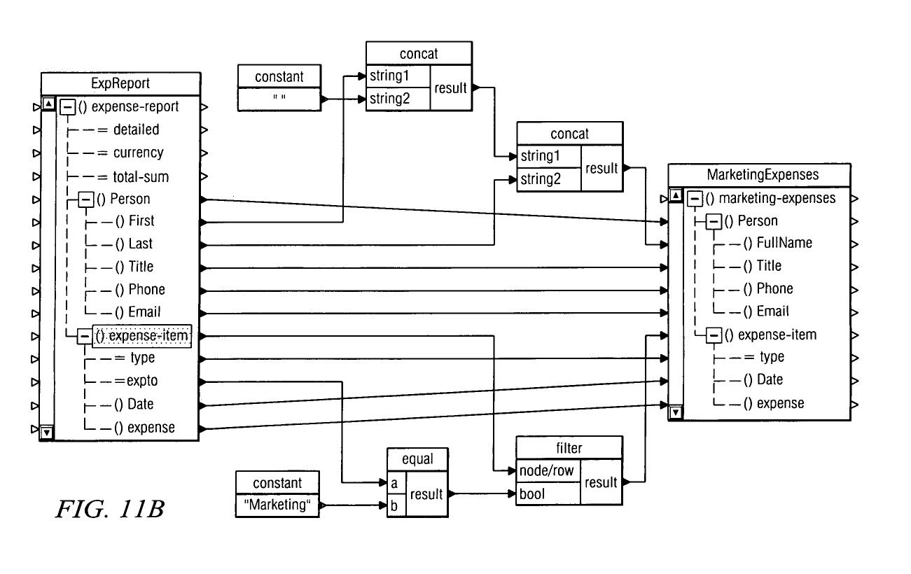

Other data transformations are done in a similar manner. For example, FIG. 11 illustrates a user developing an XML-to-XML mapping, with the user simply loading two or more XML schemas (FIG. 11A) and visually defining the data mappings and data processing functions (FIG. 11B). The resulting XSLT can then be generated by selecting the output tab or using a file menu, as shown in FIG. 11C.

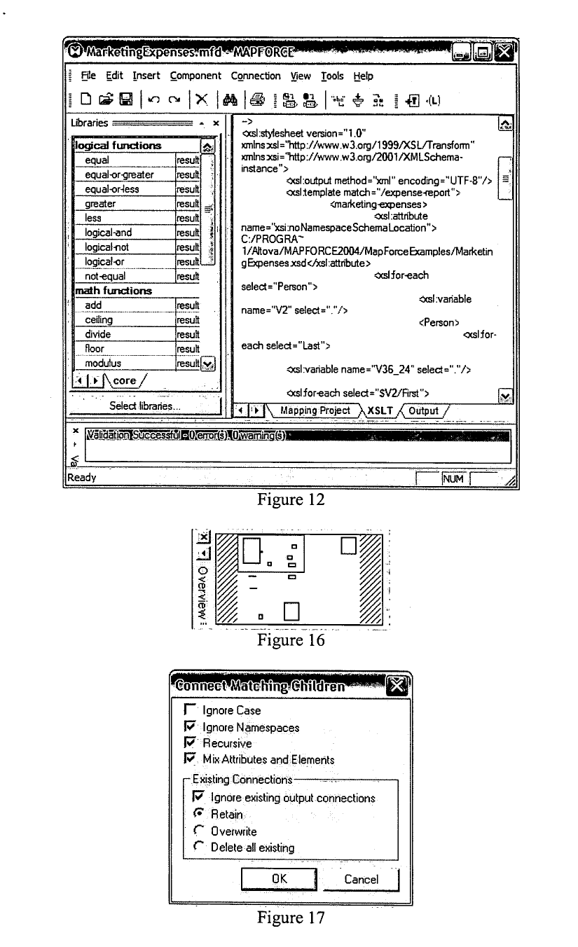

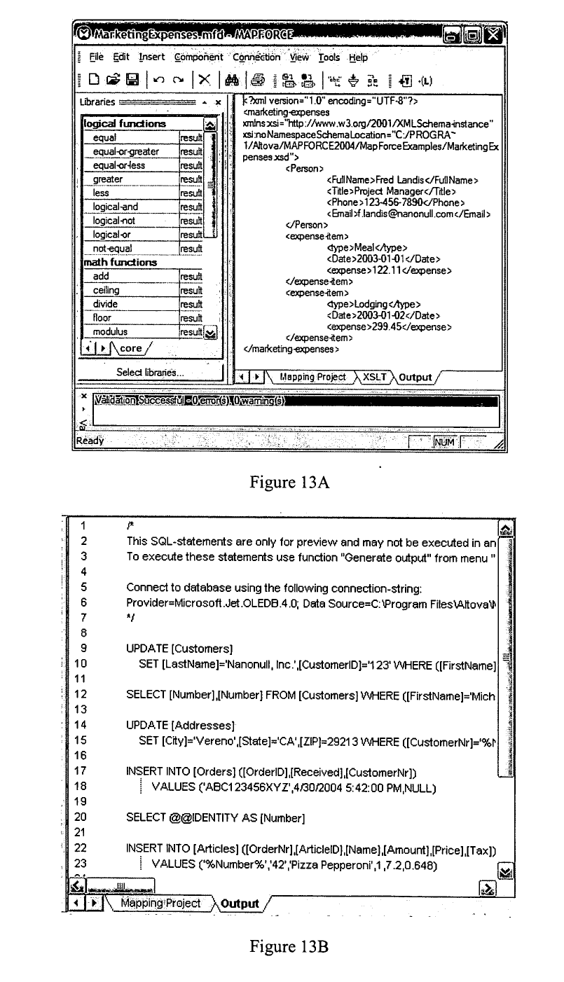

As noted above, the inventive tool provides several additional functions to assist with the integration project. As data mappings are being visually designed, preferably the system auto-generates program code. At any time, the developer can preview code by selecting the appropriate one of the preview tabs 66 in the VDE. FIG. 12 illustrates an XSLT stylesheet code that is generated in a representative embodiment. By providing sample data and clicking on the output tab, the user can also preview the results of the sample transformation itself. This is illustrated in FIG. 13A. In addition to previewing the XLST stylesheets and transformations, the system allows the developer to preview program code and output for XML/EDI/database mappings to XML and databases. Preferably, the output preview tab displays an XML file if the target of the mapping is an XML Schema. When mapping to a database, preferably the output preview displays the SQL commands that would be executed against the database as a result of the mapping. This output preview is illustrated in FIG. 13B in a representative example. Preferably, the output preview is interactive, providing flexible support for insert/update/delete database commands. In a preferred embodiment, the system also allows the developer to actually run the SQL script to execute the transformation and make the changes to the database.

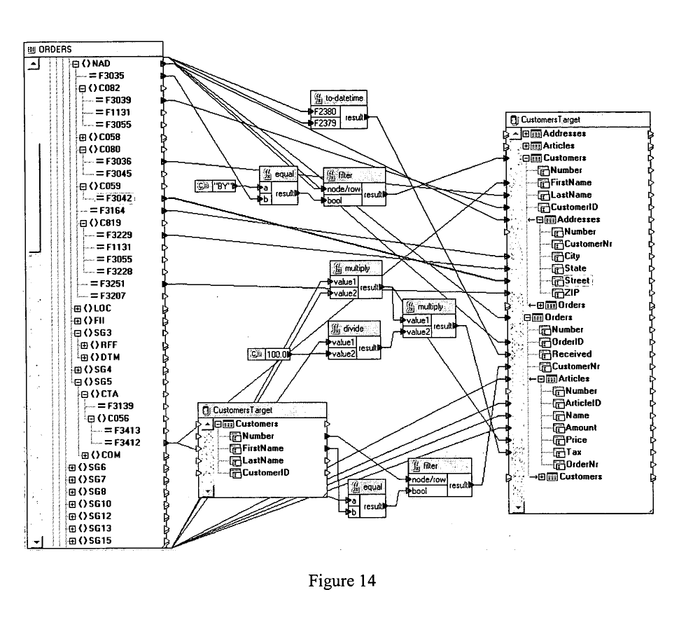

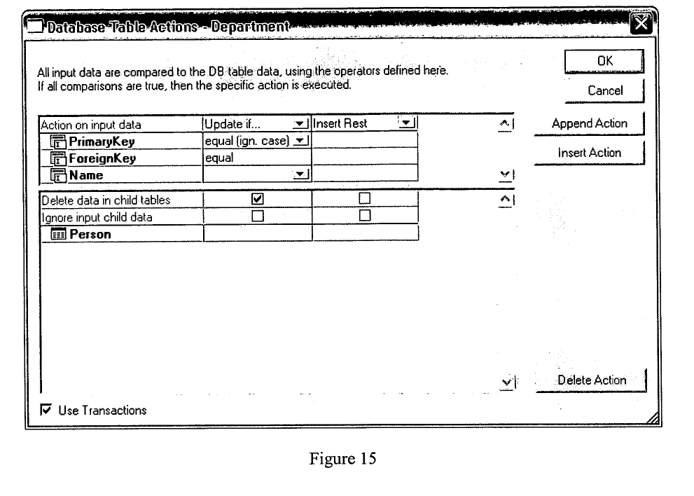

As noted above, databases may be used as both the source and/or target of a given mapping, which allows, among others: EDI-to-database, XML-to-database, database-to-XML, or database-to-database mappings. When a database structure in loaded in the design window, preferably the system automatically interprets the database schema, allowing the user to pick available database tables and views, and recognizes table relationships. Once the user confirms a given selection, preferably the system displays all chosen top-level and related tables in a hierarchical tree structure. After the content models are loaded, the user draws connecting lines between the source and target objects, such as illustrated in FIG. 14. When the user is mapping to a database, preferably the system also allows the user to select database table actions to control how data is written to the database. This allows the user flexibility to automate advanced data management tasks. FIG. 15 illustrates a representative Database Table Actions dialog box from which the user (for example) may define the columns within a selected table to be used to determine what action (INSERT, UPDATE, DELETE, etc.) should be executed in the database. The dialog also allows a user to customize how primary and foreign key values will be added to the database. The user can either provide values for the keys or allow the database system to handle the generation of auto-values.

As also described above, the present invention may be used to perform EDI mappings. EDI is a widely-used, standard format for exchanging information electronically. UN/EDIFACT (United Nations Electronic Data Interchange for Administration Commerce and Transport) is the de facto standard in use today. The use of EDIFACT for EDI has allowed organizations to increase efficiency and productivity by exchanging large amounts of information with other companies in a quick and standardized way. However, as organizations that use EDIFACT increasingly use the Internet to exchange information with customers and partners, it has become a challenge to integrate data from EDIFACT sources with other common content formats, such as databases and XML, to enable e-business applications. The present invention simplifies EDIFACT data integration by allowing the user to easily define mappings between EDIFACT sources and XML or database data using the visual mapper, as has been described. As has been described, a user can develop an EDI mapping by loading one or more EDI sources in the display environment, and then by creating mappings to any number of XML schemas and databases; e.g., by dragging connecting lines from the source(s) to the target(s).

The system may also include additional graphic design elements and underlying code to facilitate the mapping process that has been previously described. To this end, FIG. 16 illustrates a mapping overview window that allows the user to visualize an entire mapping project and to zoom in on specific areas as required. In addition, while scrolling through the project itself, the overview window indicates the user's position in the design map. This feature helps the user navigate even a large mapping project. According to another feature, when designing a given mapping, the system optionally connects matching child elements as the user drags connecting lines between the elements of a source and target. This feature saves the user time, especially when developing large mappings comprising structures that contain elements with multiple children. FIG. 17 illustrates a display menu from which a user select various configurable options with respect to the feature.

Generalizing, according to the present invention, in response to a given visual data mapping being carried out within the VDE, program code is automatically generated and available for previewing and/or testing. FIG. 12 illustrates one type of program code, namely, an XSLT stylesheet, as has been described. The invention is not limited to this embodiment, however, as the given program code may be generated in other languages such as Java, C++, C#, and others. Of course, the particular type of code generation will depend on the code generation functionality built into or otherwise associated with the tool.

According to another feature of the invention, preferably the system also includes given interpreter code (an “interpreter”) that takes a design created by the user (in the form of a “design” file in a given file format) and directly interprets that file to produce an output. Preferably, the output generated by the interpreter is the same (or substantially the same) as the output the user would obtain upon generating the code, compiling it, and then running it in a given execution environment. Thus, the design file interpreter takes a native design file and interprets it directly to preview for the user the output of the transformation.

Variants

While the present invention has been described in the context of a visual design environment that includes a drag-and-drop interface, this is not a requirement of the invention. One of ordinary skill will appreciate that other techniques may be used to associate information from the data source representation into the output document format. Illustrative techniques include a clipboard, keyboard entry, an OLE data transfer mechanism, or the like.

The particular orientation of the display window, the library functions and/or the output tabs and other controls illustrated in FIG. 2 are not meant be taken to limit the present invention. The visual design environment may juxtapose the structured data objects to facilitate the drag-and-drop functionality in any convenient visual orientation or alignment.

As noted above, according to the invention, visual mappings between any first set of one or more structured data objects and any second set of one or more structured objects automatically generates given program code; this code is then useful in programmatic data transformation from the first set to the second set in a given application execution environment. Preferably, although not required, the code-generation functionality is built upon a flexible template mechanism that allows a user to modify or even create his or her own templates to add code-generation for additional languages. In one embodiment, a code generator may comprise one or more default templates. A given template automatically generates class definitions corresponding to all declared elements or complex types that redefine any complex type in a given XML Schema, preserving the class derivation as defined by extensions of complex types in the XML Schema. In the case of a complex schema that imports schema components from multiple namespaces, the generator preferably preserves this information by generating the appropriate (for example only) C++ namespaces or Java packages. The code generator may also implement functions that read XML files into a Document Object Model (DOM) in-memory representation, write XML files from a DOM representation back to a system file, as well as that provide XML validation and transformation. Preferably, as noted above, the output program code is expressed in any desired output, such as C++, Java or C# programming languages. In a representative embodiment, the C++ generated output uses MSXML 4.0 and includes a Visual Studio 6.0 project file. The generated Java output preferably is written against the industry-standard Java API for XML Parsing (JAXP) and includes a Sun Forte for Java project file. The C# output preferably uses the .NET XML classes and can be used from any .NET capable programming language (e.g. VB.NET, Managed C++, J# or any of the several languages that target the .NET platform).

Generalizing, preferably the output code is customizable via a template language that gives full control in mapping XML Schema built-in data-types to the primitive data types of a particular programming language. The use of templates allows the user to easily replace the underlying parsing and validating engine, customize code according to given writing conventions, or to use different base libraries, such as Microsoft Foundation Classes (MFC) and Standard Template Library (STL). Built-in code generation frees software developers from the mundane task writing low level infrastructure code, enabling them to focus on implementing critical business logic. By automatically generating a programming language binding, the present invention accelerates project development time from initial design to final implementation, resulting in substantial cost savings and time to market advantages.

Thus, according to a feature of the present invention, once a user has finished defining the data mappings and data manipulations among a set of set of “n” structured data objects, the system auto-generates program code, in one or more programming languages, that can be used in given software application(s). The ability to auto-generate program code in various programming languages provides significant performance benefits when used in conjunction with XML transformations in an enterprise's mission-critical applications. Moreover, as described above, as the user designs a given mapping project, the built-in interpreter engine allows the user to preview the program code output.

The present invention provides many advantages. As is well known, XML technologies enable the integration of enterprise data, allowing organizations to realize the benefits of interconnected business systems. The present invention provides a unique XML-based approach to enterprise data integration. Using the visual design environment, data architects can simply draw visual mappings from one or more structured data objects, e.g., an XML document, an XML document and a relational database, or the like, to any data model defined in XML Schema. The system then auto-generates the software program code required to programmatically marshal data from the source to the target XML Schema for use, for example, in a customized server-side data integration application. The inventive approach to integration (such as database integration) ensures compatibility and interoperability across different platforms, servers, programming languages, and database environments.

Marshalling relational data into an XML format is often only part of the work required in a data integration project. The next step is transforming data from one XML format to another, e.g., using XSLT (extensible Stylesheet Language Transformations). For example, a common requirement is transforming one company's XML-based purchase order to correspond to a different company's purchase order to enable an e-commerce transaction on the Internet. The present invention provides an intuitive graphical user interface for defining such XML-to-XML mappings based on XML Schema.

Data integration projects rate among the most tedious developer tasks due to the volume of infrastructure code required to perform routine operations on data such as loading, persisting, validating, and the like. The present invention ameliorates these issues, and it provides data integration productivity enhancements, enabling the generation of often thousands of lines of program code and XSLT stylesheets, which would otherwise take a significant amount of time to do manually.

The system ensures that data transformation code is written consistently across an entire integration project, because preferably code is auto-generated according to globally defined, highly-configurable code generation parameters and options, rather then having multiple engineers manually implement the code. This high degree of software code consistency helps reduce and isolate software bugs while improving overall code readability and reusability. By using the present invention, there is no longer any requirement to manually write overly-complex stylesheets. Software developers can let the system handle the generation of low-level infrastructure code so they may instead focus on implementing business logic, thereby building better quality XML applications faster.

As described above, the present invention can be used to automatically generate program code to move data from any relational database into XML. In a representative embodiment, the inventive system supports all commercial relational databases, including Microsoft SQL Server and Oracle9i (via OCI), MySQL, Sybase, IBM DB2, or any database with ADO or ODBC connectivity.

The present invention also allows users to visually develop advanced XML-to-XML mappings between XML content models defined in XML Schema. Users can load any number of XML Schemas and visually define mappings between the target and the source. In a representative embodiment, the visual design environment provides a tabbed design window that allows the designer to preview both the generated XSLT stylesheet and sample output as he or she works. This straightforward approach saves time and simplifies data integration.

Moreover, the present invention can be used to handle the most advanced XML data mapping scenarios using the associated data mapping function library. As described above, this library enables the user to define data processing functions, which are data manipulation rules based on conditions, boolean logic, string operations, mathematical computations, or any other user-defined function. In addition, the inventive data integration system supports advanced multi-pass data transformations (from schema, to schema-to-schema, and the like), for which the designer simply inserts more XML Schemas into the visual design environment and draws additional mappings. In addition, in a preferred embodiment the system implements XML-to-XML transformation code in programming languages such as Java, C++ or C# (instead of XSLT) for applications demanding extra performance. The present invention thus provides for a simple and easy-to-use tool for developing custom XML data mappings.

The present invention is also highly advantageous in that it enables the user to generate code from the same design in different programming languages. Thus, the invention is suited ideally for heterogeneous development environments wherein the same mapping or transformation may be needed in more than one system. Thus, from the same mapping design, a user can generate a first mapping, e.g., in C++ or C#, to run on a Windows client (both with or without NET support) as well as a second mapping, e.g., in Java to run in a J2EE application server. This feature is quite useful, and it is a by-product of the inventive ability to generate code in multiple programming languages from one mapping design.

Preferably, the present invention is implemented in a data processing system, such as a computer or computer system having an operating system, appropriate software utilities, and applications such as an XML development environment. Although not meant to be limiting, preferably the invention is compatible with any existing or later developed relational databases, e.g., through implementation of OCI, ODBC, and ADO functionalities. The prior art, in contrast, are bound are particular server, database or middleware products, which is undesirable.

Having described our invention, what we claim is as follows.

1. A data integration method operative in a data processing system having a windows-based graphical user interface (GUI), comprising:
(a) displaying “n” structured data objects, wherein any given structured data object is positionable in any juxtaposition with respect to any other given structured data object;
(b) visually defining mappings between at least a first structured data object and a second structured data object, each mapping taking one or more data elements of the first structured data object and associating the one or more data elements, or an output from a data processing function thereof, to one or more data elements in the second structured data object; and
(c) responsive to step (b), automatically generating given program code, wherein the given program code enables programmatic data transformation from the first structured data object to the second structured data object in a given application execution environment.

2. The data integration method as described in claim 1 wherein the first structured data object is selected from a set of data objects that include: an XML document, a database, an electronic data interchange (EDI) document, or combinations thereof.

3. The data integration method as described in claim 2 wherein the second structured data object is selected from a set of data objects that include: an XML document, a relational database, or combinations thereof.

4. The data integration method as described in claim 1 wherein the given program code is generated in at least one of the following language: Java, C++, C#, or XSLT.

5. The data integration method as described in claim 4 further including the step of selectively displaying a preview of the programmatic data transformation.

6. The data integration method as described in claim 1 further including the steps of:
storing a given structured data object; and
retrieving from storage and re-using the given structured data object in a subsequent data integration design.

7. The data integration method as described in claim 1 further including the step of:
repeating steps (a)-(c) to generate new given program code upon a change in the first structured data object.

8. The data integration method as described in claim 1 wherein the data processing function is selected from a set of functions that include: a logical comparison, a mathematical computation, a string operation, a value checking operation, or a data modifier operation.

9. A data integration method operative in a data processing system having a windows-based graphical user interface (GUI), comprising the unordered steps:
(a) displaying “n” structured data objects, wherein any given structured data object is positionable in any juxtaposition with respect to any other given structured data object;
(b) displaying a given data processing element;
(c) visually defining at least one mapping from a first structured data object to a second structured data object through the given data processing element; and
(d) responsive to step (c), automatically generating given program code, wherein the given program code enables programmatic data transformation from the first structured data object to the second structured data object in a given application execution environment.

10. The data integration method as described in claim 9 wherein the data processing element generates a data processing function selected from a set of functions that include: a logical comparison, a mathematical computation, a string operation, a value checking operation, or a data modifier operation.

11. The data integration method as described in claim 9 wherein step (c) comprises visually defining one or more mappings from the first structured data object to the given data processing element, with an output thereof then associated to one or more data elements in the second structured data object.

12. A data object for use in a data integration display method, comprising:
a structured content model representation;
a first set of one or more sockets representing one or more inputs to the structured content model representation; and
a second set of one or more sockets representing one or more outputs from the structured content model representation;
wherein the sockets facilitate creation of a given visual mapping when the data object is displayed in juxtaposition with one or more other data objects.

13. The data object as described in claim 12 wherein the structured content model representation is an XML schema.

14. The data object as described in claim 12 wherein the structured content model representation is a relational database.

15. The data object as described in claim 12 wherein the structured content model representation is an EDI document.

16. A data processing system having a windows-based graphical user interface (GUI), comprising:
a display environment in which “n” structured data objects are displayed, wherein any given structured data object is positionable in any juxtaposition with respect to any other given structured data object;
code responsive to visual mappings among the structured data objects for automatically generating given program code, wherein the given program code enables programmatic data transformation from any first set of one or more structured data objects to any second set of the one more structured data objects in a given application execution environment.

17. The data processing system as described in claim 16 wherein the first set of one or more structured data objects is selected from a set of data objects that include: an XML document, a database, an electronic data interchange (EDI) document, or combinations thereof.

18. The data processing system as described in claim 16 wherein the second set of one or more structured data objects is selected from a set of data objects that include: an XML document, a relational database, or combinations thereof.

19. The data processing system as described in claim 16 further including code for selectively displaying a preview of the programmatic data transformation.

20. The data processing system as described in claim 19 wherein the code for selectively displaying a preview comprises an interpreter.

21. The data processing system as described in claim 20 wherein the interpreter generates an output that is displayable without compilation.

22. The data processing system as described in claim 16 wherein the one or more visual mappings from the first structured data object to the second structured data object include a mapping from the first structured data object to the second structured data object through a given data processing element.

23. The data processing system as described in claim 16 wherein the data processing element generates a data processing function selected from a set of functions that include: a logical comparison, a mathematical computation, a string operation, a value checking operation, or a data modifier operation.

24. The data processing system as described in claim 23 wherein the data processing function is an operation encapsulating one or more visual mappings associated with other structured data objects.

25. A data integration method operative in a data processing system having a windows-based graphical user interface (GUI), comprising the unordered steps:
(a) displaying “n” structured data objects, wherein any given structured data object is positionable in any juxtaposition with respect to any other given structured data object;
(b) visually defining one or more mappings from any first set of one or more structured data objects to any second set of one or more structured data objects;
(c) responsive to step (b), automatically generating given program code, wherein the given program code enables programmatic data transformation from any first set of one or more structured data objects to any second set of one or more structured data objects in a given application execution environment; and
(d) selectively displaying a preview of the programmatic data transformation.

26. A data integration method operative in a data processing system having a windows-based graphical user interface (GUI), comprising the unordered steps:
(a) displaying, in juxtaposition, a set of two or more structured data objects, wherein a given structured data object comprises:
a structured content model representation;
a first set of one or more sockets representing one or more inputs to the structured content model representation; and
a second set of one or more sockets representing one or more outputs from the structured content model representation;
(b) visually defining mappings among given elements of the structured data objects;
(c) responsive to step (b), automatically generating given program code, wherein the given program code enables programmatic data transformation in a given application execution environment.

27. The data integration method as described in claim 1 wherein the given program code is automatically generated using a given code generation template.

28. The data integration method as described in claim 1 further including the step of automatically matching child elements as a given mapping occurs between the first structured data object the second structured data object.

29. The data integration method as described in claim 1 further including displaying an overview window in which the “n” structured data objects and their positions within a mapping can be visualized.
